(19) United States
(12) Patent Application Publication
(10) Pub. No.: US 2012/0310481 A1
(43) Pub. Date: Dec. 6, 2012

(54) METHOD FOR OPERATING A DRIVER ASSISTANCE SYSTEM OF A MOTOR VEHICLE AND DRIVER ASSISTANCE SYSTEM FOR A MOTOR VEHICLE

(75) Inventors: Torsten KANNING, Eltville-Erbach (DE); Justus ILLIUM, Mainz (DE)

(73) Assignee: GM GLOBAL TECHNOLOGY OPERATIONS LLC, Detroit, MI (US)

(21) Appl. No.: 13/481,457

(22) Filed: May 25, 2012

(30) Foreign Application Priority Data
May 31, 2011 (DE) 10 2011 102 916.1

(51) Int. Cl. B62D 6/00; B60Q 5/00; B60Q 1/00

(52) U.S. Cl. 701/41; 701/1

(57) ABSTRACT

A method for operating a driver assistance system of a motor vehicle wherein the driver assistance system is configured as a parking aid system is provided. The method includes determining a parameter characterizing an impending parking procedure of the motor vehicle in a longitudinal direction of the vehicle. A first distance d₁ of a lateral face of the motor vehicle on a driver's side to a parking space periphery on the driver's side is determined and a second distance d₂ of a lateral face of the motor vehicle on a passenger's side to a parking space periphery on the passenger's side is determined. Information for a centered parking of the motor vehicle relative to the parking space periphery on the driver's side and to the parking space periphery on the passenger's side based on the first distance d₁ and the second distance d₂ is issued by an issuing device.

### CROSS-REFERENCE TO RELATED APPLICATION

This application claims priority to German Patent Application No. 10 2011 102 916.1, filed May 31, 2011, which is incorporated herein by reference in its entirety.

### TECHNICAL FIELD

The technical field generally relates to a method for operating a driver assistance system of a motor vehicle, driver assistance systems for a motor vehicle, computer program products, and a computer-readable medium.

### BACKGROUND

From DE 38 13 083 A1 a device is known, able to be installed in a motor vehicle, for facilitating a parking procedure in parallel or right-angled direction. The device consists of motion sensors for measuring the movement distance of the automobile, obstacle sensors for determining the position of the obstacles around an automobile, and a microcomputer. The microcomputer generates numerous signals in accordance with the instructions of the driver and the data obtained from the above-mentioned motion sensors and obstacle sensors in order to instruct the driver to advance the automobile, to stop, to drive to the left or to the right, or to reverse, in order to park the automobile along a specific course. The microcomputer can, in addition, generate an output signal in order to control the steering mechanism, the gear shifting, the acceleration device, and the braking system in order to park the automobile automatically.

At least one object herein is to provide methods for operating a driver assistance system of a motor vehicle, driver assistance systems for a motor vehicle, computer program products and a computer-readable medium, which enable a further improved parking aid. In addition, other objects, desirable features and characteristics will become apparent from the subsequent summary and detailed description, and the appended claims, taken in conjunction with the accompanying drawings and this background.

### SUMMARY

A method for operating a driver assistance system of a motor vehicle is provided. The driver assistance system is configured as a parking aid system. In an embodiment, a determining takes place of a parameter characterizing an impending parking procedure of the motor vehicle in the longitudinal direction of the vehicle. In addition, a determining takes place of a first distance d1 of a lateral face of the motor vehicle on the driver's side to a parking space periphery on the driver's side. In addition, a determining takes place of a second distance d2 of a lateral face of the motor vehicle on the passenger's side to a parking space periphery on the passenger's side. Furthermore, an issuing of information takes place for a centered parking of the motor vehicle relative to the parking space periphery on the driver's side and to the parking space periphery on the passenger's side, based on the determined first distance d1 and the determined second distance d2 by an issuing device.

The method according to an embodiment enables a further improved parking aid. This takes place by the determining of the first distance d1 and of the second distance d2 and the issuing of information for a centered parking of the motor vehicle. Thereby, information is provided to the driver of the motor vehicle, by means of which the motor vehicle can be parked in a centered manner, i.e. can be parked such that the first distance d1 corresponds substantially to the second distance d2. Thereby, the motor vehicle has as equal as possible a distance to the parking space peripheries on the driver's and passenger's sides, whereby the likelihood of damage to the motor vehicle during and after the parking procedure can be reduced. The method therefore enables in particular a safe and easier parking of the motor vehicle in a car-wash or in a garage or respectively parking space. Furthermore, the method is advantageous for parking procedures in parking garages. Moreover, the method enables a greater comfort for the driver of the motor vehicle during parking procedures.

In an embodiment, the information contains the determined first distance d1 and the determined second distance d2. In this embodiment, the driver of the motor vehicle is therefore provided with the determined distances, whereby he can park the motor vehicle in a simple manner with as equal a lateral distance as possible. In addition, the information can contain the position of the motor vehicle together with the respective distances d1 and d2. Furthermore, the information can contain instructions for turning a steering wheel of the motor vehicle for a centered parking of the motor vehicle.

The issuing device can be configured as an acoustic and/or visual issuing device. For example, the issuing device can be a component of an instrument cluster of the motor vehicle or of an information and entertainment system of the motor vehicle.

In another embodiment, a method for operating a driver assistance system of a motor vehicle is provided wherein the driver assistance system is configured as a parking aid. The method has the following steps here. A determining takes place of a parameter characterizing an impending parking procedure of the motor vehicle in the longitudinal direction of the vehicle. In addition, a determining takes place of a first distance d1 of a lateral face of the motor vehicle on the driver's side to a parking space periphery on the driver's side. Furthermore, a determining takes place of a second distance d2 of a lateral face of the motor vehicle on the passenger's side to a parking space periphery on the passenger's side. Furthermore, an automatic actuation of a steering device of the motor vehicle takes place based on the determined first distance d1 and the determined second distance d2, such that the motor vehicle is parked in a centered manner to the parking space periphery on the driver's side and to the parking spacing periphery on the passenger's side.

The method according to this embodiment also enables a further improved parking aid, wherein in this arrangement a centered parking of the motor vehicle takes place by the automatic actuation of the steering device. Thereby, in an embodiment a fully automatic parking function is provided by an electronic steering wheel intervention. In addition an automatic actuation of a brake device and/or of a drive device of the motor vehicle can take place during the parking procedure, in order to enable a fully automatic parking function.

In an embodiment, the determining of the first distance d1 and/or the determining of the second distance d2 takes place by data of a sensor of the motor vehicle.

The sensor of the motor vehicle can be chosen from an electromagnetic sensor, in particular a radar sensor or a lidar sensor, and an acoustic sensor, in particular an ultrasonic sensor. The sensors, which are also designated as environmental sensors, are coming into use to an increased extent in motor vehicles, whereby the number of components additionally required for the method can be reduced.

The sensor of the motor vehicle can be configured in particular as a parking sensor and/or as a sensor for blind spot monitoring. The sensors can therefore be used for the method and thereby the number of additionally required components for the method can again be reduced.

The parameter characterizing an impending parking procedure of the motor vehicle in the longitudinal direction of the vehicle can be an engaging of a reverse gear, in particular of a gear transmission of the motor vehicle. Furthermore, the parameter can be a falling below of a predetermined speed of the motor vehicle. The parameters are particularly suited here to determine such an impending parking procedure of the motor vehicle in the longitudinal direction of the vehicle.

Furthermore, the parameter can be an actuation of an activating device of the driver assistance system by an occupant of the motor vehicle, in particular by the driver of the motor vehicle. Thereby, he can automatically activate the parking aid function on driving into the parking space.

Also provided in an embodiment is a driver assistance system for a motor vehicle which has a first determining device configured for determining a parameter characterizing an impending parking procedure of the motor vehicle in the longitudinal direction of the vehicle. In addition, the driver assistance system has a second determining device, which is configured for determining a first distance d1 of a lateral face of the motor vehicle on the driver's side to a parking space periphery on the driver's side. Furthermore, the driver assistance system has a third determining device, which is configured for determining a second distance d2 of a lateral face of the motor vehicle on the passenger's side to a parking space periphery on the passenger's side. Moreover, the driver assistance system has an issuing device, configured for issuing information for a centered parking of the motor vehicle relative to the parking space periphery on the driver's side and to the parking space periphery on the passenger's side, based on the determined first distance d1 and the determined second distance d2.

In another embodiment, a driver assistance system for a motor vehicle has a first determining device configured for determining a parameter characterizing an impending parking procedure of the motor vehicle in the longitudinal direction of the vehicle. In addition, the driver assistance system has a second determining device, which is configured for determining a first distance d1 of a lateral face of the motor vehicle on the driver's side to a parking space periphery on the driver's side. Moreover, the driver assistance system has a third determining device, which is configured for determining a second distance d2 of a lateral face of the motor vehicle on the passenger's side to a parking space periphery on the passenger's side. Furthermore, the driver assistance system has an actuating device configured for the automatic actuation of a steering device of the motor vehicle based on the determined first distance d1 and the determined second distance d2. In this regard, the motor vehicle is parked in a centered manner to the parking space periphery on the driver's side and to the parking space periphery on the passenger's side.

In addition, in an embodiment, a computer program, when executed on a computer program product, such as a processing unit, of a driver assistance system of a motor vehicle and when the driver assistance system is configured as a parking aid system, instructs the processing unit to carry out the following steps. The processing unit is instructed to determine a parameter characterizing an impending parking procedure of the motor vehicle in the longitudinal direction of the vehicle. In addition, the processing unit is instructed to determine a first distance d1 of a lateral face of the motor vehicle on the driver's side to a parking space periphery on the driver's side. Furthermore, the processing unit is instructed to determine a second distance d2 of a lateral face of the motor vehicle on the passenger's side to a parking space periphery on the passenger's side. Furthermore, the processing unit is instructed to issue information for a centered parking of the motor vehicle relative to the parking space periphery on the driver's side and to the parking space periphery on the passenger's side by means of an issuing device based on the determined first distance d1 and the determined second distance d2.

Furthermore, in an embodiment, a computer program, when executed on a processing unit of a driver assistance system of a motor vehicle and when the driver assistance system is configured as a parking aid system, instructs the processing unit to carry out the following steps. The processing unit is instructed to determine a parameter characterizing an impending parking procedure of the motor vehicle in the longitudinal direction of the vehicle. In addition, the processing unit is instructed to determine a first distance d1 of a lateral face of the motor vehicle on the driver's side to a parking space periphery on the driver's side. Furthermore, the processing unit is instructed to determine a second distance d2 of a lateral face of the motor vehicle on the passenger's side to a parking space periphery on the passenger's side. Moreover, the processing unit is instructed to automatically actuate a steering device of the motor vehicle based on the determined first distance d1 and the determined second distance d2, such that the motor vehicle is parked in a centered manner to the parking space periphery on the driver's side and to the parking space periphery on the passenger's side.

According to a further embodiment, a computer-readable medium on which a computer program according to one or more of the embodiments described above is stored is provided.

In the above-mentioned embodiments, the motor vehicle is, for example, an automobile or a truck.

### BRIEF DESCRIPTION OF THE DRAWINGS

The various embodiments will hereinafter be described in conjunction with the following drawing figures, wherein like numerals denote like elements, and wherein:

FIG. 1 shows a flow diagram of a method for operating a driver assistance system of a motor vehicle according to an embodiment;

FIG. 2 shows a flow diagram of a method for operating a driver assistance system of a motor vehicle according to another embodiment;

FIGS. 3A and 3B show an example of a parking procedure in which the methods according to the various embodiments can be used;

FIG. 4 shows a driver assistance system of the motor vehicle shown in FIGS. 3A and 3b according to an embodiment; and

FIG. 5 shows a driver assistance system of the motor vehicle shown in FIGS. 3A and 3B according to another embodiment.

### DETAILED DESCRIPTION

The following detailed description is merely exemplary in nature and is not intended to limit the various embodiments or the application and uses thereof. Furthermore, there is no intention to be bound by any theory presented in the preceding background or summary or the following detailed description.

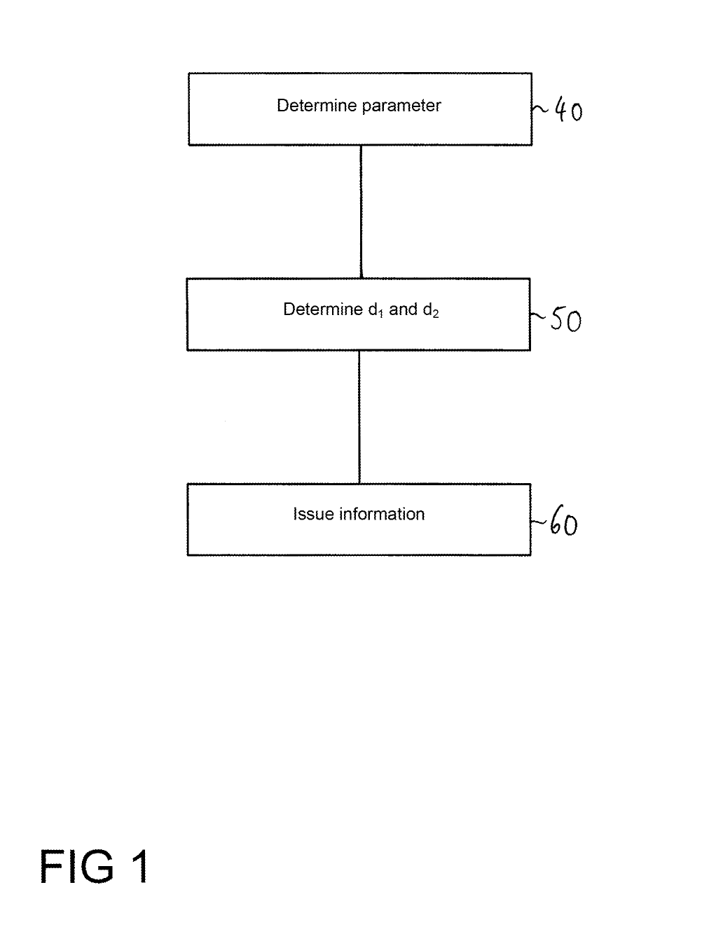

FIG. 1 shows a flow diagram of a method for operating a driver assistance system of a motor vehicle according to an embodiment. The driver assistance system is configured here as a parking aid system. The motor vehicle is, for example, an automobile or a truck.

In a step 40 a determining takes place of a parameter characterizing an impending parking procedure of the motor vehicle in the longitudinal direction of the vehicle. The parameter can be the engaging of a reverse gear of a gear transmission of the motor vehicle. Furthermore, the parameter can be a falling below of a predetermined speed of the motor vehicle. In a further arrangement, the parameter is an actuation of an activating device of the driver assistance system by an occupant of the motor vehicle, for example, by the driver of the motor vehicle.

In a step 50 in the embodiment which is shown a determining takes place of a first distance d1 of a lateral face of the motor vehicle on the driver's side to a parking space periphery on the driver's side. In addition, in the step 50 a determining takes place of a second distance d2 of a lateral face of the motor vehicle on the passenger's side to a parking space periphery on the passenger's side. The lateral face on the driver's side can be formed here by a side wall of the motor vehicle on the driver's side. Accordingly, the lateral face on the passenger's side can be formed by a side wall of the motor vehicle on the passenger's side. The corresponding peripheries here can be, for example, walls of a garage or of a car wash. Furthermore, the peripheries can also be formed by lateral faces of other motor vehicles.

In an embodiment, the determining of the first distance d1 and of the second distance d2 takes place at the same time by data of a first sensor and of a second sensor of the motor vehicle. The first and/or the second sensor is, for example, chosen from an electromagnetic sensor, in particular a radar or lidar sensor, and an acoustic sensor, in particular an ultrasonic sensor. The first and/or the second sensor can additionally be configured as a parking sensor and/or as a sensor for blind spot monitoring. However, it is also possible that the first and/or the second sensor is provided in addition to a parking sensor or a sensor for blind spot monitoring.

In a step 60 in the embodiment which is shown, an issuing of information takes place for a centered parking of the motor vehicle relative to the parking space periphery on the driver's side and to the parking space periphery on the passenger's side based on the determined first distance d1 and on the determined second distance d2 by an issuing device of the motor vehicle. The information, in an embodiment, contains the determined first distance d1 and the determined second distance d2 and further the position of the motor vehicle relative to the parking space peripheries. Furthermore, it is possible that the information contains instructions for turning a steering wheel of the motor vehicle for a centered parking of the motor vehicle. The issuing device is configured, for example, as an acoustic and/or visual issuing device and can be a component of an instrument cluster or of an information and entertainment system of the motor vehicle.

The steps 50 and 60 are carried out repeatedly, i.e. the determining of the first distance d1 and the determining of the second distance d2 and the issuing of the information take place repeatedly, until the parking procedure of the motor vehicle is completed and it is parked as centered as possible to the parking space periphery on the driver's side and on the passenger's side.

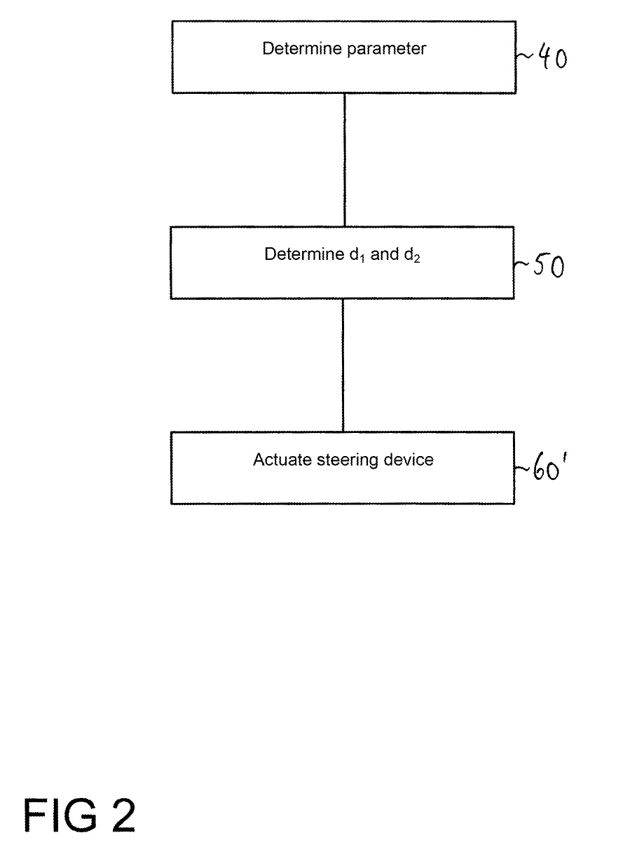

FIG. 2 shows a flow diagram of a method for operating a driver assistance system of a motor vehicle according to another embodiment. The driver assistance system is again configured as a parking aid system and the motor vehicle is, for example, an automobile or a truck.

In the embodiment which is shown, in a step 40 a determining takes place of a parameter characterizing an impending parking procedure of the motor vehicle in the longitudinal direction of the vehicle in accordance with the step 40 of the embodiment shown in FIG. 1.

Furthermore, in a step 50 a determining takes place of a first distance d1 of a lateral face of the motor vehicle on the driver's side to a parking space periphery on the driver's side and of a second distance d2 of a lateral face of the motor vehicle on the passenger's side to a parking space periphery on the passenger's side in accordance with the step 50 of the first embodiment shown in FIG. 1.

In addition, in the embodiment which is shown, in a step 60′ an automatic actuating of a steering device of the motor vehicle takes place based on the determined first distance d1 and the determined second distance d2, such that the motor vehicle is parked centered to the parking spacing periphery on the driver's side and to the parking space periphery on the passenger's side.

The steps 50 and 60′ are again carried out repeatedly in order to enable a substantially centered parking of the motor vehicle.

In the embodiments which are shown, therefore for example by the lateral parking sensors, which are used for measuring a parking space, the driver of the motor vehicle or respectively the motor vehicle is directed with as equal as possible lateral distance for example into a car wash entrance or garage entrance, so that the vehicle can be parked in a centered manner. On driving into the garage or into the car wash, the center of the vehicle or respectively the lateral distances of the motor vehicle to the corresponding parking space peripheries is determined by the lateral parking sensors for measuring a parking space. The position and the distance to the respective lateral faces or respectively side walls can be indicated to the driver in a vehicle display. In the embodiment shown in FIG. 2, the function is coupled with a fully automatic parking function in the form of an electronic steering wheel intervention. When driving into a garage or into a car wash, the driver can therefore activate the function for example by a switch, and the corresponding driver assistance system of the motor vehicle determines automatically the center of the entrance or respectively steers the vehicle automatically into the center. The parking sensors are included here so that the vehicle does not cause any contact with the wall.

The methods according to the embodiments enable a benefit to the customer through a greater comfort and provide a new function. Furthermore, a safe and easier parking of the motor vehicle is enabled for example in a car wash or in a garage or respectively parking space.

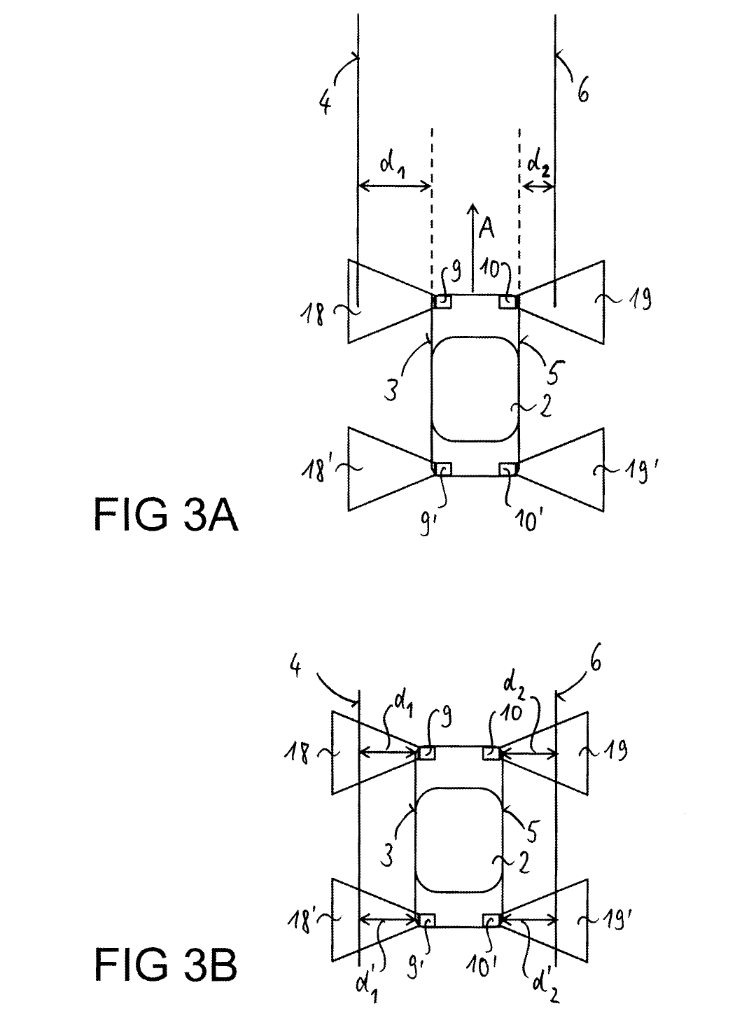

FIGS. 3A and 3B show an example of a parking procedure in which the methods according to the embodiments can be used, in particular the methods according to the embodiments shown in FIGS. 1 and 2. Components with the same functions are designated here by the same reference numbers.

In the situation illustrated in FIG. 3A, a motor vehicle 2, which in the example shown is an automobile, travels in a travel direction represented diagrammatically by an arrow A. The travel direction corresponds substantially to a vehicle longitudinal direction of the motor vehicle 2.

The motor vehicle 2 is situated at the start of a parking procedure in the longitudinal direction of the vehicle, i.e. in the travel direction of the motor vehicle 2, into a parking space arranged in the longitudinal direction of the vehicle, of which a parking space periphery 4 on the driver's side and a parking space periphery 6 on the passenger's side are illustrated. The corresponding peripheries can be, for example, walls of a garage or of a car wash. Furthermore, the peripheries can also be formed by lateral faces of further motor vehicles, for example in a parking garage.

In the embodiment which is shown, the motor vehicle 2 has sensors 9 and 9′ on the driver's side and sensors 10, 10′ on the passenger's side. The sensors 9 and 10 are situated here in the region of a front bumper and the sensors 9′ and 10′ in the region of a rear bumper of the motor vehicle 2. The sensors 9, 9′, 10 and 10′ are configured for example as electromagnetic sensors, in particular as radar or as lidar sensors, or as acoustic sensors, in particular as ultrasonic sensors. Furthermore, the sensors can be configured as a parking sensor of the motor vehicle.

The sensors 9 and 9′ have diagrammatically illustrated detection ranges 18 or respectively 18′, which extend respectively into a region of the lateral environment of the motor vehicle 2 on the driver's side. The sensors 10 and 10′ have detection ranges 19 or respectively 19′, which extend respectively into a region of the lateral environment of the motor vehicle 2 on the passenger's side.

In the situation shown in FIG. 3A, the parking space periphery 4 on the driver's side is situated at least partially within the detection range 18 of the sensor 9, and the parking space periphery 6 on the passenger's side is situated at least partially within the detection range 19 of the sensor 10. Thereby, by data of the sensor 9, a first distance d1 can be determined of a lateral face 3 of the motor vehicle 2 on the driver's side to the parking space periphery 4 on the driver's side, and by data of the sensor 10, a second distance d2 can be determined of a lateral face 5 of the motor vehicle 2 on the passenger's side to the parking space periphery 6 on the passenger's side.

In the situation shown in FIG. 3A at the start of the parking procedure, the first distance d1 is greater than the second distance d2. As will be explained in further detail in connection with the following figures, a centered parking of the motor vehicle 2 can be enabled by a driver assistance system configured as a parking aid system.

FIG. 3B shows the motor vehicle 2 at the end of the parking procedure, wherein by the corresponding driver assistance system a centered parking has taken place, i.e. the first distance d1 of the lateral face 3 on the driver's side to the parking space periphery 4 on the driver's side corresponds substantially to the second distance d2 of the lateral face 5 on the passenger's side to the parking space periphery 6 on the passenger's side.

In the situation which is shown, by the sensors 9 and 10 the first distance d1 or respectively the second distance d2 is determined at a front end of the motor vehicle 2. In addition, by the sensors 9′ and 10′ a distance d1′ of the lateral face 3 on the driver's side to the parking space periphery 4 on the driver's side or respectively a distance d2′ of the lateral face 5 on the passenger's side to the parking space periphery 6 on the passenger's side is determined at a rear end of the motor vehicle 2. The first distance d1 corresponds in the situation shown substantially to the distance d1′ and the latter in turn substantially to the distance d2′. The motor vehicle 2 is therefore parked in a centered manner in the parking space both in the front region and also in the rear region.

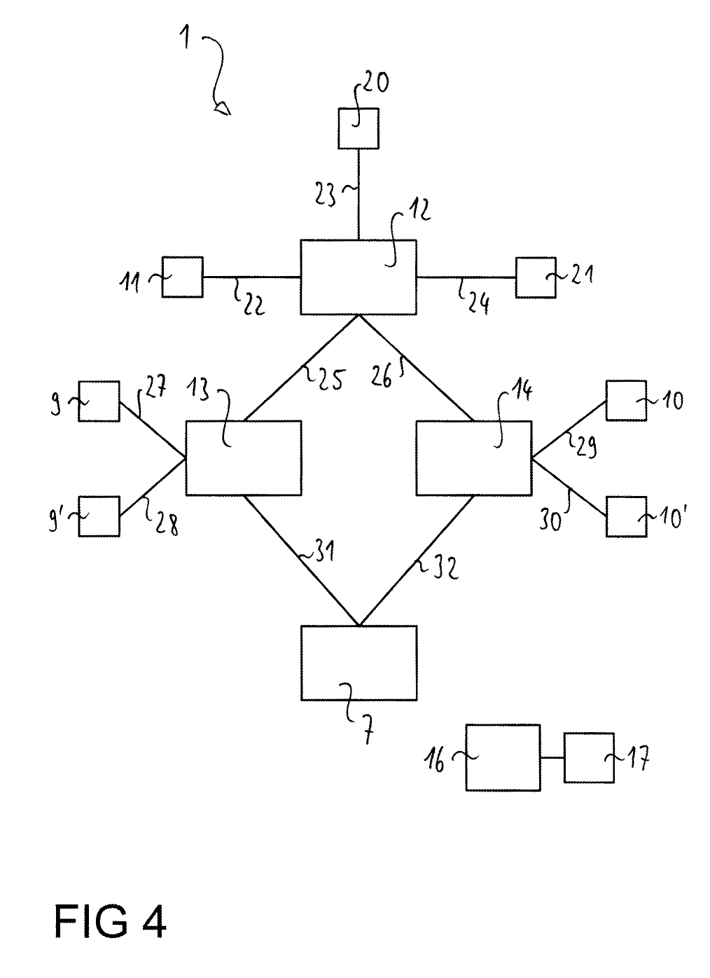

FIG. 4 shows a driver assistance system 1 of the motor vehicle shown in FIGS. 3A and 3B according to an embodiment. Components with the same functions as in FIGS. 3A and 3B are designated by the same reference numbers and are not explained again in the following.

The driver assistance system 1 is configured as a parking aid system and has a first determining device 12 which is configured for determining a parameter characterizing an impending parking procedure of the motor vehicle in the longitudinal direction of the vehicle.

For this, in the embodiment shown, the first determining device 12 is connected via a signal line 22 with an activating device 11 of the driver assistance system 1, which is configured for example as a switch. By actuation of the activating device 11, an occupant of the motor vehicle can activate the driver assistance system 1.

Furthermore, in the embodiment shown, the first determining device 12 is connected with a sensor 20 via a signal line 23. By data determined by the sensor 20, an engaging of a reverse gear of a gear transmission of the motor vehicle and hence an impending parking procedure of the motor vehicle in reverse direction can be determined.

Furthermore, the first determining device 12 is connected with a sensor 21 via a signal line 24, wherein the sensor 21 is configured for determining the speed of the motor vehicle. In the case of a falling below of a predetermined speed of the motor vehicle, thereby likewise an impending parking procedure can be determined.

The driver assistance system 1 has in addition a second determining device 13, which is configured for determining a first distance d1 of a lateral face of the motor vehicle on the driver's side to a parking space periphery on the driver's side. For this, in the embodiment shown, the second determining device 13 is connected with the sensor 9 via a signal line 27 and with the sensor 9′ via a signal line 28.

Furthermore, the driver assistance system 1 has a third determining device 14, which is configured for determining a second distance d2 of a lateral face of the motor vehicle on the passenger's side to a parking space periphery on the passenger's side. For this, in the embodiment shown, the third determining device 14 is connected with the sensor 10 via a signal line 29 and with the sensor 10′ via a signal line 30.

The first determining device 12 is connected with the second determining device 13 via a signal line 25 and with the third determining device 14 via a signal line 26.

In addition, the driver assistance system 1 has an issuing device 7 which is configured for the issuing of information for a centered parking of the motor vehicle relative to the parking space periphery on the driver's side and to the parking space periphery on the passenger's side based on the determined first distance d1 and the determined second distance d2. For this, the issuing device 7 is connected with the second determining device 13 via a signal line 31 and with the third determining device 14 via a signal line 32. In addition, the information can contain the position of the motor vehicle together with the respective distances d1 and d2.

The issuing device 7 is configured for example as an acoustic and/or visual issuing device and can be a component of an instrument cluster of the motor vehicle or of an information and entertainment system of the motor vehicle.

In a further arrangement, the information contains instructions for turning a steering wheel of the motor vehicle for a centered parking of the motor vehicle. For this, a determining device which is not illustrated in further detail is connected with a steering wheel angle sensor and with the issuing device.

In the embodiment shown, the driver assistance system 1 has in addition a processing unit 16 and a computer-readable medium 17, wherein on the computer-readable medium 17 a computer program is stored which, when it is executed on the processing unit 16, instructs the processing unit 16 to carry out the steps named in connection with the embodiments of the method, in particular the steps of the method according to FIG. 1, by means of the elements named there. For this, the processing unit 16 is connected directly or indirectly with the corresponding elements in a manner not illustrated in further detail.

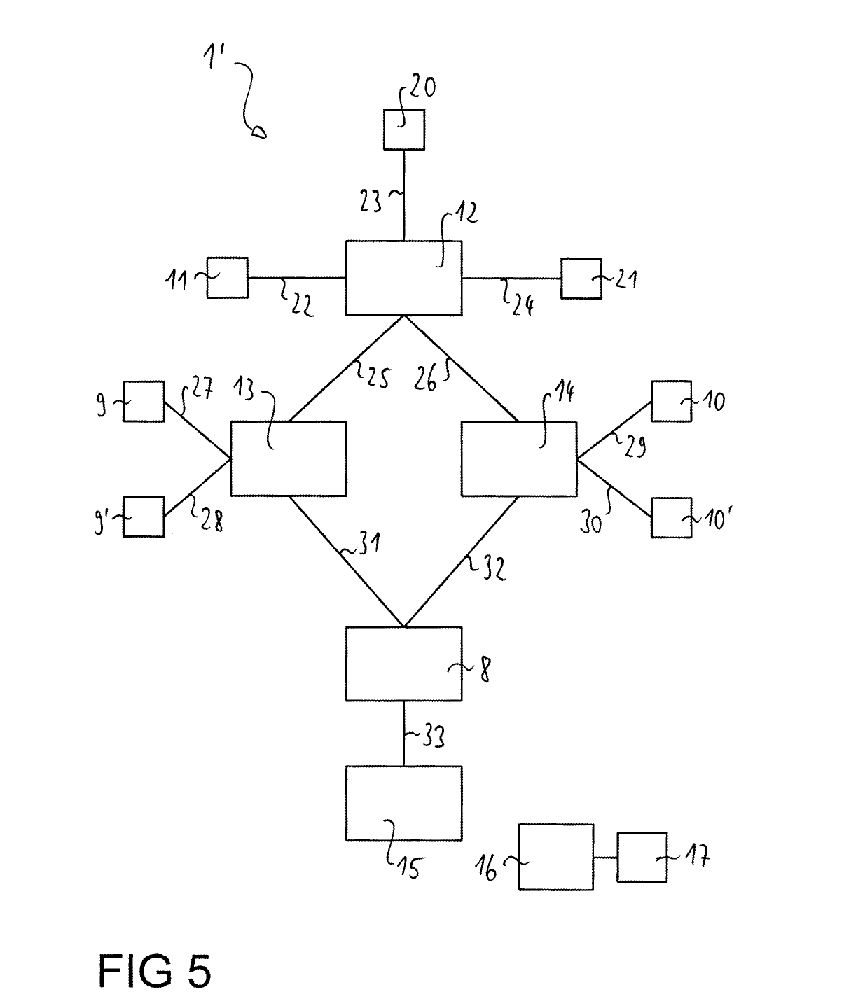

FIG. 5 shows a driver assistance system 1′ of the motor vehicle shown in FIGS. 3A and 3B according to another embodiment. Components with the same functions as in the preceding figures are designated by the same reference numbers and are not explained again in the following.

In the embodiment, the driver assistance system 1′ again has a first determining device 12, a second determining device 13 and a third determining device 14, which are configured in accordance with the first determining device, the second determining device and the third determining device of the first embodiment shown in FIG. 4.

In addition, the driver assistance system 1′ has an actuating device 15 which is configured for the automatic actuation of a steering device of the motor vehicle, not illustrated in further detail, based on the determined first distance d1 and the determined second distance d2, such that the motor vehicle is parked in a centered manner to the parking space periphery on the driver's side and to the parking space periphery on the passenger's side. For this, the actuating device 15 is connected with a control unit 8 via a control- and signal line 33. The control unit 8 is, in addition, connected with the second determining device 13 via a signal line 31 and with the third determining device 14 via a signal line 32. Thereby, a centered parking of the motor vehicle is enabled.

In the embodiment shown, the driver assistance system 1′ has in addition a processing unit 16 and a computer-readable medium 17, wherein on the computer-readable medium 17 a computer program is stored which, when it is executed on the processing unit 16, instructs the processing unit 16 to carry out the steps named in connection with the embodiments of the method, in particular the steps of the method according to FIG. 2, by the elements named there. For this, the processing unit 16 is connected directly or indirectly with the corresponding elements in a manner not illustrated in further detail.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for operating a driver assistance system of a motor vehicle, wherein the driver assistance system is configured as a parking aid system, and wherein the method comprises the steps of:
determining a parameter characterizing an impending parking procedure of the motor vehicle in a longitudinal direction of the motor vehicle;
determining a first distance d₁ of a lateral face of the motor vehicle on a driver's side to a parking space periphery on the driver's side;
determining a second distance d₂ of a lateral face of the motor vehicle on a passenger's side to a parking space periphery on the passenger's side; and
issuing of information for a centered parking of the motor vehicle relative to the parking space periphery on the driver's side and to the parking space periphery on the passenger's side based on the first distance d₁ and the second distance d₂ by an issuing device.

2. The method according to claim 1, wherein issuing comprises issuing of the information containing the first distance d₁ and the second distance d_{z}.

3. The method according to claim 1, wherein issuing comprises issuing of the information by the issuing device configured as an acoustic and/or visual issuing device.

4. A method for operating a driver assistance system of a motor vehicle, wherein the driver assistance system is configured as a parking aid system, and wherein the method comprises the steps of:
determining a parameter characterizing an impending parking procedure of the motor vehicle in a longitudinal direction of the motor vehicle;
determining a first distance d₁ of a lateral face of the motor vehicle on a driver's side to a parking space periphery on the driver's side; determining a second distance d₂ of a lateral face of the motor vehicle on a passenger's side to a parking space periphery on the passenger's side; and
automatically actuating a steering device of the motor vehicle based on the first distance d₁ and the second distance d₂, such that the motor vehicle is parked in a centered manner to the parking space periphery on the driver's side and to the parking space periphery on the passenger's side.

5. The method according to claim 4, wherein determining the first distance d₁ and/or determining the second distance d₂ is performed using data of a sensor of the motor vehicle.

6. The method according to claim 5, wherein determining the first distance d₁ and/or determining the second distance d₂ is performed using the data of an electromagnetic sensor or an acoustic sensor.

7. The method according to claim 5, wherein determining the first distance d₁ and/or determining the second distance d₂ is performed using the data of a parking sensor and/or a sensor for blind spot monitoring.

8. The method according to claim 4, wherein determining the parameter comprises determining of the engaging of a reverse gear of the motor vehicle.

9. The method according to claim 4, wherein determining the parameter comprises determining of a falling below of a predetermined speed of the motor vehicle.

10. The method according to claim 4, wherein determining the parameter comprises determining an actuation of an activating device of the driver assistance system by an occupant of the motor vehicle.

11. A driver assistance system for a motor vehicle, comprising:
a first determining device configured for determining a parameter characterizing an impending parking procedure of the motor vehicle in a longitudinal direction of the motor vehicle;
a second determining device configured for determining a first distance d₁ of a lateral face of the motor vehicle on a driver's side to a parking space periphery on the driver's side;
a third determining device configured for determining a second distance d₂ of a lateral face of the motor vehicle on a passenger's side to a parking space periphery on the passenger's side; and
an issuing device configured for issuing information for a centered parking of the motor vehicle relative to the parking space periphery on the driver's side and to the parking space periphery on the passenger's side based on the first distance d₁ and the second distance d₂.

12. A driver assistance system for a motor vehicle, the driver assistance system comprising:
a first determining device configured for determining a parameter characterizing an impending parking procedure of the motor vehicle in a longitudinal direction of the motor vehicle;
a second determining device configured for determining a first distance d₁ of a lateral face of the motor vehicle on a driver's side to a parking space periphery on the driver's side;
a third determining device configured for determining a second distance d₂ of a lateral face of the motor vehicle on a passenger's side to a parking space periphery on the passenger's side; and
an actuating device configured for an automatic actuation of a steering device of the motor vehicle based on the first distance d₁ and the second distance d₂, such that the motor vehicle is parked in a centered manner to the parking space periphery on the driver's side and to the parking space periphery on the passenger's side.

13. A computer readable medium embodying a processing unit of a driver assistance system of a motor vehicle, the processing unit comprising a computer program which, when executed on the processing unit and when the driver assistance system is configured as a parking aid system, is configured to:
determine a parameter characterizing an impending parking procedure of the motor vehicle in a longitudinal direction of the motor vehicle;
determine a first distance d₁ of a lateral face of the motor vehicle on a driver's side to a parking space periphery on the driver's side;
determine a second distance d₂ of a lateral face of the motor vehicle on a passenger's side to a parking space periphery on the passenger's side;
issue information for a centered parking of the motor vehicle relative to the parking space periphery on the driver's side and to the parking space periphery on the passenger's side based on the first distance d₁ and the second distance d₂ by an issuing device.

14. A computer readable medium embodying a processing unit of a driver assistance system of a motor vehicle, the processing unit comprising a computer program which, when executed on the processing unit and when the driver assistance system is configured as a parking aid system, is configured to:
determine a parameter characterizing an impending parking procedure of the motor vehicle in a longitudinal direction of the motor vehicle;
determine a first distance d₁ of a lateral face of the motor vehicle on a driver's side to a parking space periphery on the driver's side;
determine a second distance d₂ of a lateral face of the motor vehicle on a passenger's side to a parking space periphery on the passenger's side; and
automatically actuate a steering device of the motor vehicle based on the first distance d₁ and the second distance d₂, such that the motor vehicle is parked in a centered manner relative to the parking space periphery on the driver's side and to the parking space periphery on the passenger's side.
